(19) United States
(12) Patent Application Publication
(10) Pub. No.: US 2008/0131055 A1
(43) Pub. Date: Jun. 5, 2008

(54) Keyed push-pull type fiber optic connection system

(76) Inventors: L. Edward Parkman, Richland Hills, TX (US); Peter Travis, Denton, TX (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/633,327

(22) Filed: Dec. 4, 2006

(51) Int. Cl. G02B 6/36

(52) U.S. Cl. 385/58

(57) ABSTRACT

A connection system for providing selective interconnection between a fiber optic connector plug and a receptacle socket. The connection system is configured for implementation in push-pull type connectors having a dual housing structure, including an inner housing and an outer housing. The connection system comprises a connector inner housing and connector outer housing having predefined keying geometries, including protrusions and channels/slots that may be formed onto the outer and inner surfaces of the respective connection devices. The connection system further comprises a receptacle socket, including protrusions and channels that may be formed onto the inner surface of the connection device. The protrusions and channels formed on the connector's inner and outer housing are configured to mate with corresponding keying features found on the receptacle socket, thus allowing properly keyed connection devices to interconnect.

### FIELD OF THE INVENTION

The present invention relates to fiber optic connectors, and specifically, to a connection system for mating a fiber optic connector plug with a receptacle socket, each having corresponding keying features formed on their respective inner and/or outer surfaces, such that only properly keyed connection devices may interconnect with one another.

### DESCRIPTION OF THE RELATED ART

A connector plug may be mounted on the terminal end of a fiber optic line in order to aid in further connecting the line. Fiber optic lines may be connected to other fiber optic lines in order to increase the overall length of a transmission line. A fiber optic line may also be connected to a terminal device designed to receive signals transmitted through said line. However, disruptions in signal transmission may occur any time a fiber optic line is terminated.

Various interconnectivity devices are revealed in the prior art which seek to minimize the potential losses that may occur due to line termination. These interconnectivity devices often employ the use of connector plugs and receptacle sockets. A fiber optic line may be terminated with a connector plug, which may then be inserted into a receptacle socket configured to receive the respective connector. Several types of connection system utilizes what is known as a push-pull type of connector plug and corresponding receptacle socket. Push-pull type connectors are so named because latching features that secure the connection between the connector plug and the receptacle socket are engaged by a user delivered pushing force, and disengaged by a user delivered pulling force. Push-pull type connectors are configured to employ two housing structures, as opposed to the single housing structure seen in other connectors found in prior art connection systems. The housing structures of push-pull type connectors are comprised generally of an inner housing and an outer housing. The inner housing is configured to mount within the outer housing structure, allowing the inner housing and outer housing to move relative to one another.

A need exists, for a variety of reasons, to limit access to fiber optic networks. The prior art reveals various connection systems configured to physically limit the means by which a connector may be inserted into a receptacle, so as to restrict access to a network. The systems revealed in the prior art depend upon a variety of methods for physically restricting the insertion of connectors into receptacles, such that only certain connectors may be inserted into specifically configured receptacles.

Push-pull type fiber optic connection systems possess functional elements which present unique issues relating to security not found in other types of connectors. For example, a keying feature found only on the outer housing of a standard push-pull type connector, may be circumvented by the removal of the outer housing. Thus, any security feature implemented with respect to push-pull type connectors, must accommodate the dual housing structures found on such devices. A connection system successfully implemented into a push-pull type connection system must also not interfere with the means by which the connector plug connects and disconnects with the receptacle socket. Therefore, any keying features must be configured so as not to obstruct the proper functioning of the latching features found on the push-pull connection system.

A connection system for restricting the interconnectivity between a connector and a receptacle is revealed in the U.S. patent application published with the No. 2002/0126960, which is comprised of a keyed connector plug and a correspondingly keyed receptacle socket. Both the connector plug and receptacle socket utilize distinct geometric moldings within their respective inner surfaces, such that only those devices with corresponding moldings may successfully interconnect. The system is configured for use in a one-piece style connector and therefore does not address the unique functional and security problems associated with push-pull style connectors. If the keying features revealed in the prior art were implemented with respect to the inner surface of a push-pull type receptacle socket, the keying features would likely interfere with the latching features also found on the inner surface of the receptacle socket. Additionally, if the keying features revealed in the prior art were implemented with respect to the inner surface of a push pull type receptacle socket, the keying features could be easily circumvented by the removal of the connector's outer housing. With the connector outer housing removed, the inner housing (containing the fiber optic line) could be freely inserted into the receptacle socket.

Another connection system for restricting the interconnection between a connector plug and a receptacle socket is revealed in the U.S. patent application published with the No. 2005/0117850, which is comprised of a connector plug and a receptacle socket, each with a predefined keying geometry. The predefined keying geometries employ both a raised boss and a cavity. The raised boss may be located on either the forward end of the connector plug or the receptacle socket, and the cavity is formed on the other of the forward end of the connector plug or the receptacle socket. The keying geometries, including predefined keying angles of the raised bosses and cavities found within the connector plug and receptacle socket, must correspond in order for them to be successfully interconnected. The connection system requires a housing structure with walls thick enough to accommodate a cavity or boss with an extended keying portion. However, because the inner housing of a push-pull type connector has a relatively thin wall in comparison to those found in many single housing connectors, the connection system would be impractical in a push-pull type connection system. The connection system also requires spacing between a ferrule and the inner surface of the connector inner housing structure. In many push-pull type connectors there is little or no space between the ferrule and the inner surface of the connector inner housing, thus making the keying system impractical in such connection systems.

Therefore, a need exists for a predefined connection system that will address the functional and security issues that are present in push-pull type connectors.

### SUMMARY OF THE INVENTION

The present invention overcomes many of the disadvantages of the prior art by providing for a connection system that may be successfully implemented in push-pull type fiber optic connector plugs and receptacle sockets. The push-pull type connector plug and receptacle socket found in the present invention include protrusions, channels, and slots located on their respective inner and/or outer surfaces, which allow them to successfully interconnect, while restricting interconnectivity among devices not properly keyed.

The connection system of the present invention is configured so as to prevent its circumvention by removal of the connector plug outer housing. The present invention provides for a connection system that includes a receptacle socket having a protrusion configured to mate with both housing structures of the connector plug. Thus, a standard non-keyed connector plug may not be inserted into a properly keyed receptacle socket by removing the outer housing of the connector plug. Additionally, the connection system provides for a protrusion extending from the outer surface of the connector plug inner housing, through a slot in the connector outer housing, and into a channel located inside the receptacle socket, configured to mate with the said protrusion. The presence of an inner housing protrusion ensures that only a properly keyed receptacle socket will interconnect with the connector plug, even if the outer housing has been removed from said connector plug.

The present invention further provides for a connection system which does not interfere with the functionality of the connector plug, nor the receptacle socket. The protrusions and channels/slots found on the connector's inner and outer housing do not prevent the connector's inner housing from sliding within the connector's outer housing. Furthermore, the keying features of the present invention do not interfere with the latching features configured to aid in the connection and disconnection of the connector plug and the receptacle socket.

The present invention further provides for a connection system that allows for a plurality of keying configurations. The connection system may be configured so as to provide for a plurality of protrusions and channels/slots on the connector inner housing, the connector outer housing, and the receptacle socket. The connection system may also be configured so as to allow for a plurality of positions along the keying sides of the connector inner housing, connector outer housing, and receptacle socket, in which protrusions and channels may be formed. Additionally, the protrusions and channels comprising the connection system may be configured so as to allow for a plurality of dimensions including height, width, length, and depth.

### BRIEF DESCRIPTION OF THE DRAWINGS

A more complete understanding of the connection system of the present invention may be had by reference to the following detailed description when taken in conjunction with the accompanying drawings, wherein:

FIG. 1 is a perspective view of a prior art “SC” style push-pull connector plug;

FIG. 2 is a perspective view of a prior art “SC” style push-pull receptacle socket;

FIG. 3A is a perspective view of an embodiment of an “MU” style push-pull connector plug having keying features according to the present invention;

FIG. 3B is a perspective view of an embodiment of an “MU” style push-pull connector plug having keying features according to the present invention;

FIG. 3C is a front view of an embodiment of an “MU” style push-pull connector plug nested within an “MU” style push-pull receptacle socket having keying features according to the present invention;

FIG. 3D is a rear view of an embodiment of an “MU” style push-pull connector plug nested within an “MU” style push-pull receptacle socket having keying features according to the present invention;

FIG. 4A is a perspective view of an embodiment of an “MU” style push-pull connector plug having keying features according to the present invention;

FIG. 4B is a perspective view of an embodiment of an “MU” style push-pull connector plug having keying features according to the present invention;

FIG. 5 is a perspective view of a prior art “MTP” style push-pull connector plug;

FIG. 6 is a perspective view of a prior art “MTP” style push-pull receptacle socket;

FIG. 7 is a perspective view of a preferred embodiment of a “MTP” style push-pull connector plug having keying features according to the present invention;

FIG. 8 is a perspective view of a preferred embodiment of a “MTP” style push-pull connector plug which is inserted into a “MTP” style push-pull receptacle socket, both having keying features according to the present invention;

FIG. 9 is a perspective view of a preferred embodiment of the outer housing of a “MTP” style push-pull connector plug having keying features according to the present invention;

FIG. 10 is a perspective view of a preferred embodiment of a “MTP” style push-pull connector plug inserted into a “MTP” style push-pull receptacle socket, both having keying features according to the present invention;

FIG. 11 is a perspective view of a preferred embodiment of the inner housing of a “MTP” style push-pull connector plug having keying features according to the present invention; and

FIG. 12 is a perspective view of a preferred embodiment of the inner housing of a “MTP” style push-pull receptacle socket, having keying features according to the present invention.

### DETAILED DESCRIPTION OF THE INVENTION

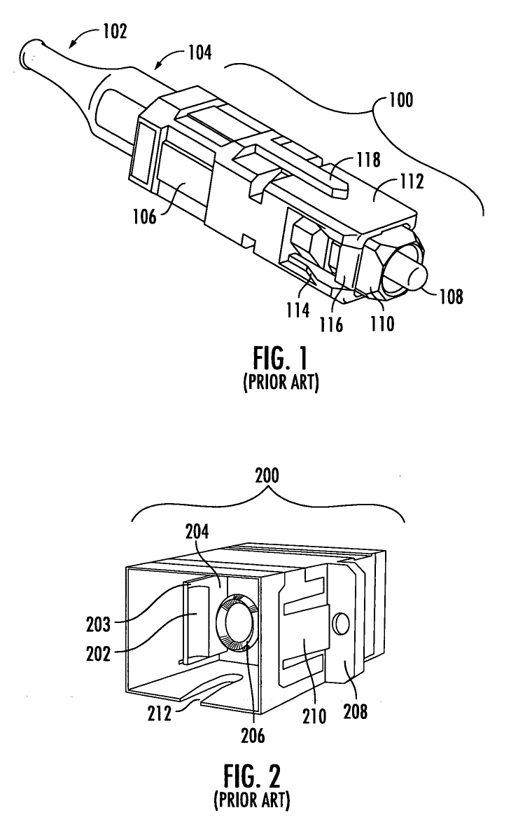

Commonly used types of push-pull connectors are “MU” and “SC” style fiber optic connector plugs. Referring to FIG. 1 and FIG. 2, embodiments of an SC style fiber optic connector plug 100 and a corresponding receptacle socket 200 found in the prior art are shown for comparison. SC and MU connectors are similar in function, thus keying options may apply to both the SC and MU connector types. The connector plug shown in FIG. 1 and the receptacle socket shown in FIG. 2 do not possess the keying features of the present invention, but are merely an example of an SC type connector plug and receptacle socket that may be found in the prior art. The connector plug 100 may be mounted to the end of a fiber optic line that is inserted through lead-in end 102. A strain relieving boot 104 provides protection from forces that may be applied to the joint (not shown) connecting the fiber optic line to the connector plug 100. The fiber optic line is comprised of both a light transmitting optical fiber (not shown) as well as a non-conductive, cylindrical, hollow ferrule 108. The ferrule 108 surrounds the optical fiber (not shown), keeping it securely bundled. The ferrule 108 is often composed of a non-conductive material such as ceramic. The terminal end of the fiber optic line contains that portion of the optical fiber (not shown) that has been cut and polished such that it may be connected to another optical fiber (not shown) without substantially diminishing the quality of signal transmission. The connector plug 100 surrounds the fiber optic line. The connector plug 100 is comprised of an inner housing 110 and an outer housing 112. Both the inner housing 110 and the outer housing 112 are typically composed of a non-conductive, plastic material. The inner housing 110 is mounted within the outer housing 112, allowing the inner housing 110 and the outer housing 112 to move relative to one another during insertion and removal of the connector plug 100.

The inner housing 110 and the outer housing 112 include latching features found on their respective outer surfaces, allowing the connector plug 100 to interconnect with the latching features within a correspondingly configured receptacle socket 200. Molded or machined latching features such as outer housing connector ramps 114 and inner housing connector notches 116 are integral to the outer surfaces of both the inner housing 110 and the outer housing 112. The inner housing connector notches 116 engage hooks 202 which are connected to latches 204 found on the corresponding receptacle socket 200 in order to provide a secure connection, thus allowing for uninterrupted signal transmission. The latching features found on the inner housing 110 ensure that said inner housing 110 is securely attached to a receptacle socket 200 such that tension applied to the line, directed away from the receptacle socket 200, will not result in disconnection of the line. The fiber optic line and connector plug 100 may be removed from the receptacle socket 200 by a user grasping the outer housing 112 of the connector plug 100 and applying a force directed away from the receptacle socket 200. The force applied to connector outer housing causes the outer housing connector ramps 114 to engage the forward side extensions 203 of the latches 204 found within the receptacle socket 200, moving them 204 outward in order to release the inner housing notches 116 from the receptacle hooks 202, thus disconnecting the fiber optic line from the receptacle socket 200. The outer surface of the connector outer housing 112 may also include features that aid in the proper insertion and alignment of the connector plug 100. A raised tab 118 may aid in properly aligning the connector plug 100 to the receptacle socket 200 during insertion. Indentations 106 found on the outer housing 112 aid in the removal of the connector plug 100 from the receptacle socket 200 by providing the user with a surface that may be firmly grasped.

Referring now to FIG. 2, an embodiment of an SC style receptacle socket 200 found in the prior art will now be described. The receptacle socket shown in FIG. 2 does not possess the keying features of the present invention, but is merely an example of an SC type receptacle socket that may be found in the prior art. The receptacle socket 200 is comprised of a single housing body which is configured to receive a connector plug 100. As previously described, receptacle hooks 202 and receptacle latches 204 engage with connector ramps 114 and connector notches 116 to provide the connector plug 100 with a secure connection within the receptacle socket 200. During insertion of the connector plug 100 into the receptacle socket 200, the fiber optic line and the ferrule 108 are inserted into a ferrule accepting receptacle cavity 206 located on the rear wall of the receptacle socket 200. The receptacle cavity 206 firmly receives the connector plug ferrule 108, allowing for proper alignment and optical interconnection of the optical fiber 106 with another optical fiber or terminal device. A pair of flanges 208 located on the outer surface of the receptacle socket 200 provides a means for mounting the device to a surface if so desired. Receptacle clips 210 provide additional means for securing the receptacle socket 200 to a surface or to a receptacle outer housing (not shown). A receptacle slot 212 may be present on the receptacle socket 200, configured to receive alignment features such as a raised tab 118 found on a connector plug 100.

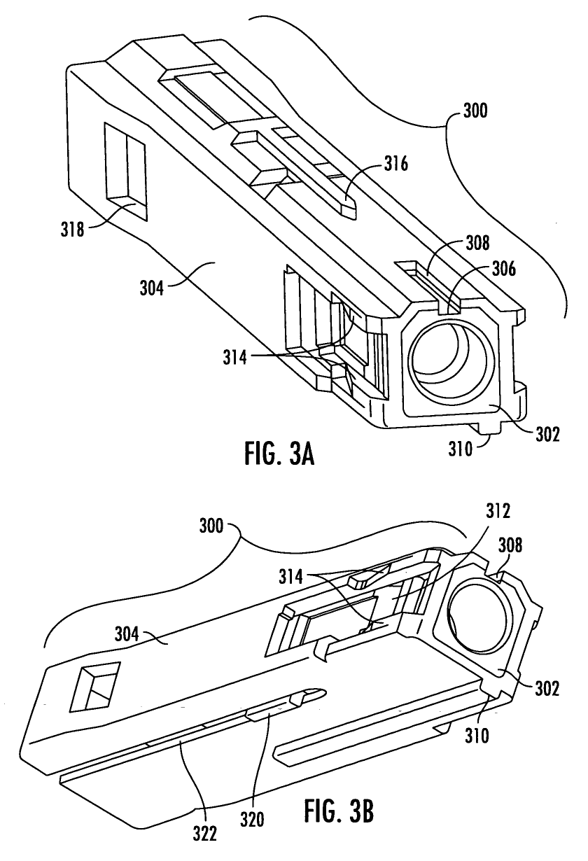

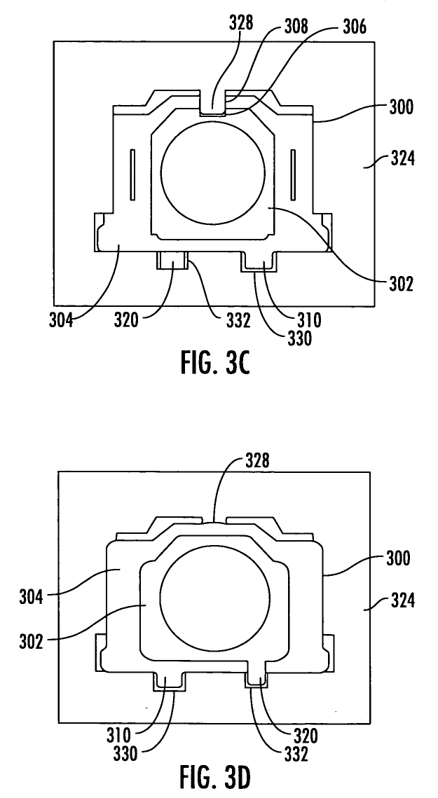

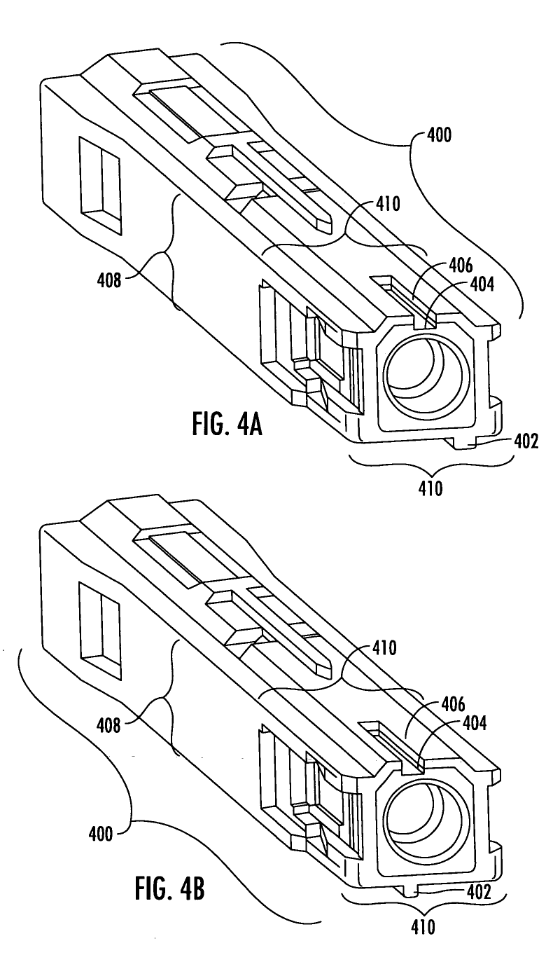

The connection system of the present invention may be implemented in a variety of push-pull type connectors, including MU connectors, MTP connectors, MPO connectors, SC connectors and any other style connector and/or adapter that functions via relative motion between inner and outer housings. The fiber optic plug and receptacle socket shown in illustrated embodiments FIG. 3A, FIG. 3B, FIG. 3C, FIG. 3D, FIG. 4A, and FIG. 4B are shown to include an MU type connector and receptacle socket by way of example, not of limitation. The ferrule has been omitted in each of the illustrated embodiments recited above.

Referring now to FIG. 3A, a preferred embodiment of an MU type connector plug 300, having keying features of the present invention, configured to mate with a correspondingly keyed receptacle socket (not shown). A connector channel 306 serves as a keying geometry on the inner housing 302 of the connector plug 300. A first outer housing slot 308, having a length and width substantially similar to that of the connector inner housing channel 306, provides access to said channel 306. Similarly, a protrusion 310 found on the outer housing 304 of the connector plug 300, serves as an additional keying geometry. The connector channel 306 and the first outer housing slot 308 mate with correspondingly dimensioned receptacle protrusion (not shown) on the receptacle socket (not shown), thus excluding the possibility that an non-keyed or improperly keyed connector plug and receptacle socket will interconnect. Similarly, the connector outer housing protrusion 310 is configured to mate with a corresponding receptacle channel (not shown), thus preventing the insertion of a keyed connector plug, into a non-keyed or improperly keyed receptacle socket (not shown). The connector plug 300 has a generally rectangular cross section having four sides. The latching features, comprising inner housing notches 312 and outer housing ramps 314, are found on two opposing sides of the connector plug's 300 four sides. No keying feature should be located on the same side as that of a latching feature unless it does not interfere with the functionality of the latching features during installation and removal of the connection plug 300.

Referring now to FIG. 3B, a preferred embodiment of an MU style connector plug 300, having keying features of the present invention, configured to mate with a correspondingly keyed receptacle socket (not shown). An inner housing protrusion 320 extends through a second outer housing slot 322. The inner housing protrusion 320 is configured to mate with a correspondingly keyed channel (not shown) found within the inner surface of a receptacle socket (not shown). The inner housing protrusion 320 provides a means for ensuring that a connector plug may not be inserted into a standard receptacle socket (not shown) following removal of the outer housing 304. The second outer housing slot 322 provides a means by which the inner housing protrusion 320 may slide within the outer housing 304 during connection and removal of the connector plug 300.

Referring now to FIG. 3C, a front view of the connector plug 300 and the receptacle socket 324, interconnected with one another, is shown in an illustrative embodiment. The inner housing 302 of the connector plug 300 is nested within the outer housing 304 of the connector plug 300. The connector protrusion 310 extends outward from the outer housing of the connector plug and mates with a first receptacle channel 330. A receptacle protrusion 328 extends inwards from the inner surface of the receptacle socket 324 and mates with the connector channel 306 found on the outer surface of the connector inner housing 302. The receptacle protrusion 328 extends through the first connector outer housing slot 308 in order to mate with the channel 306 found on the connector inner housing 302. The extension of the receptacle protrusion 328 into the inner housing connector channel 306 and first outer housing slot 308, provides an advantage not seen in the prior art. Because the outer housing 304 of some push-pull style connectors may be removed in order to bypass keying features, configuring the connection system in the present invention to provide for the extension of the receptacle protrusion 328 into the surface of the connector inner housing 302 prevents the circumvention of the keying features. Thus, a non-keyed or improperly keyed connector plug 300, with the connector outer housing 304 removed, may not interconnect with a keyed receptacle socket 324 because the receptacle protrusion 328 would physically restrict the insertion of the connector inner housing 302.

The protrusions contained in the present invention are of the form of a raised tab, extending from the surface to which they are integrally attached. The protrusions are generally rectangular in form, each having a predefined height, length, and width. Likewise, the channels contained in the present invention are also generally rectangular in form. Each channel has a predefined depth, length, and width. Each channel contains an opening on one end, allowing for mating with a correspondingly dimensioned protrusion. Similarly, each slot found on the connector plug and receptacle socket also has a predefined length and width, allowing for mating with correspondingly dimensioned protrusions. However, it should be noted that the keying geometries of alternate embodiments, including protrusions, channels, and slots, may be formed such that they are not generally rectangular in the cross section. As those skilled in the art will appreciate, keying geometries of alternate embodiments may have cross sections formed in any of a plurality of shapes and sizes.

Referring now to FIG. 3D, a rear view of the connector plug 300 and the receptacle socket 324 interconnected with one another, is shown in an illustrative embodiment. The connector inner housing 302 is nested within the connector outer housing 304. The connector inner housing protrusion 320 extends from the outer surface of the connector inner housing 302, through the second connector outer housing slot 322, and into a second receptacle channel 332. During the insertion of the connector plug 300 into the receptacle socket 324, the connector outer housing protrusion 310 and the receptacle protrusion 320, mate with the first receptacle channel 330 and second receptacle channel 332 respectively. Thus, an improperly keyed or non-keyed connector plug may not interconnect with a keyed receptacle socket 324. Likewise, an improperly keyed or non-keyed receptacle socket may not interconnect with a keyed connector plug 300.

Referring now to FIG. 4A and FIG. 4B, alternative embodiments of the present invention may be obtained by varying the placement of keying features such as protrusions 402, channels 404, and slots 406. Because the connector plug 400 of the preferred embodiment is generally rectangular in the cross section, for the purposes of this description, the connector plug 400 will be said to have four sides including a top side, bottom side, left side, and right side, when viewed from the front end of the connector plug 400. The sides that contain the latching features will be referred to hereinafter as the latching sides 408, and the sides containing the keying features will be referred to as the keying sides 410. It should be noted that although the presently preferred embodiment is configured such that the keying features are on the top side and bottom side of the connector plug 400, those skilled in the art may choose to place the keying features on the left side and right side in a manner that does not interfere with latching. Protrusions and/or slots may also be positioned on the sides of the connector/adapter in alternative embodiments. The keying features may be positioned in a plurality of locations along the keying sides 410 in such a manner as to provide multiple keying configurations. A configuration of more than one connector channel 404 and/or more than one connector protrusion 402 may be desirable in order to allow for a more complex connection system. The length, width, height/depth of the respective connector channels 404 and connector protrusions 402 may vary in order to achieve a desired security configuration or to maintain the structural integrity of the connector plug 400. Likewise the dimensions of receptacle socket 324 protrusions 328 and channels 330, 332 may also vary as necessary to properly mate with keying features found on the connector plug 400. The length, width, and height/depth of any protrusion or channel may vary in dimension as desired to provide for additional complexity of the connection system.

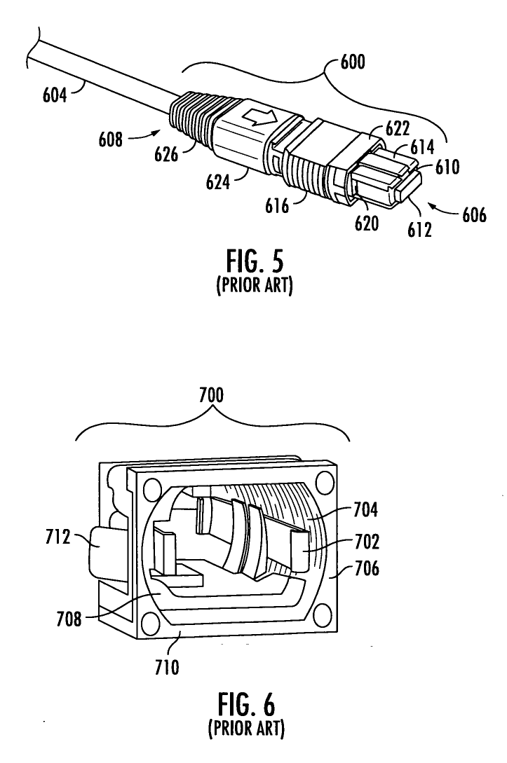

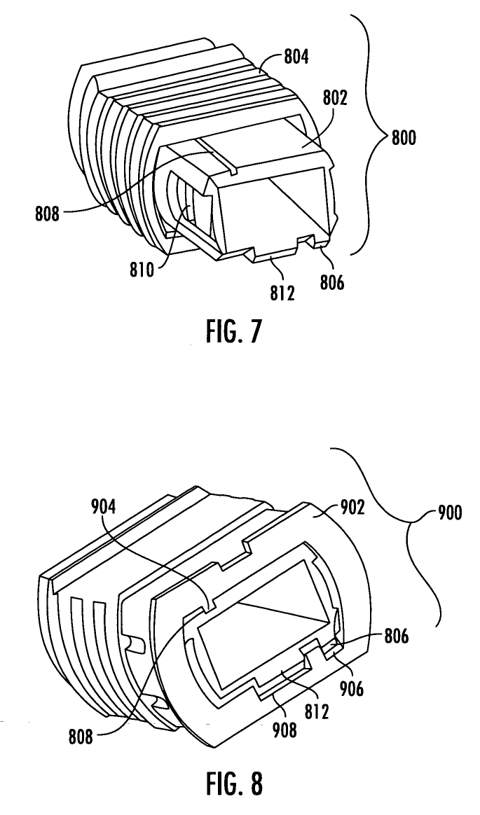

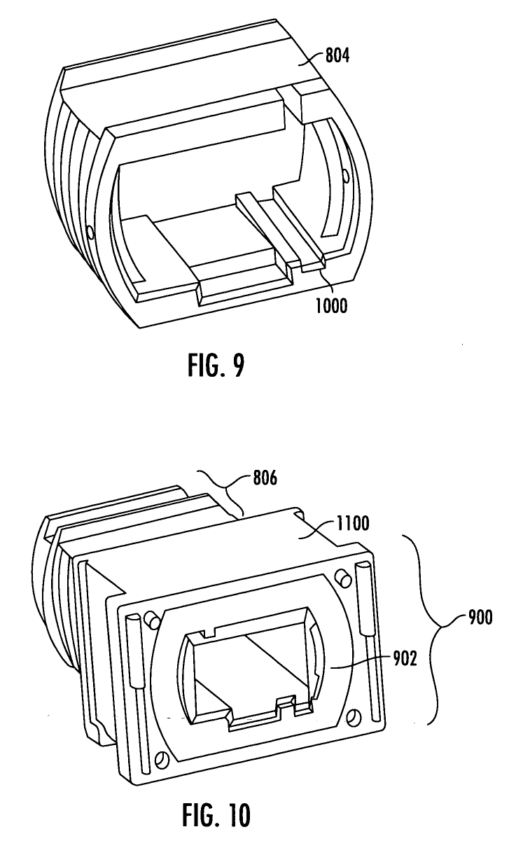

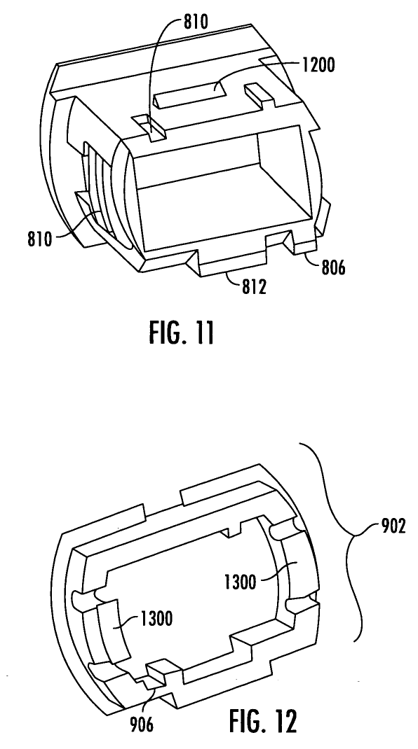

Another type of push-pull fiber optic connector plug commonly used in a variety of applications is an “MTP” type connector. “MTP” is a registered trademark of US Conec Ltd. MTP type connectors allow for the connection of multiple fibers in one connection device. The connection system of the present invention may be implemented in an MTP type connector. The fiber optic plug of the illustrated embodiments shown in FIG. 5 FIG. 6, FIG. 7, FIG. 8, FIG. 9, FIG. 10, FIG. 11, and FIG. 12 are shown to include an MTP type connector by way of example, not of limitation.

Referring now to FIG. 5 and FIG. 6, a standard MTP type connector plug 600 and receptacle socket 700 as revealed in the prior art, not possessing the keying features of the present invention, will be described in further detail. The MTP connector plug 600 houses a terminating portion of a fiber optic line 604. The connector plug 600, having a forward end 606 and a rearward end 608, houses a ferrule 610, which in turn, houses multiple optical fibers 612. The optical fibers 612 are often bundled in a ribbon cable (not shown) within the fiber optic line 604. As will be understood by those skilled in the art, the ends of the optical fibers 612 extend through openings on the forward end of the ferrule 610, allowing them to interconnect with other optical fibers (not shown) positioned within a corresponding receptacle socket 700. The MTP connector plug 600 includes a connector inner housing 614 and a connector outer housing 616. The connector outer housing 616 surrounds the middle portion of the connector inner housing 614. The connector outer housing 616 is configured to slide axially with respect to the inner housing 614, but is limited in its rearward sliding movement by a shoulder on the rearward end 608 of the connector inner housing 614. The connector outer housing 616 is limited in its forward sliding movement by a raised tab 1200 (refer to FIG. 11) located on the connector inner housing 614, when it abuts an edge of the connector outer housing 616. An internal spring mechanism (not shown) acts to keep the connector outer housing 616 at the forward limit of its sliding movement when in its natural position. The connector inner housing 614 encloses and protects the ferrule 610 and optical fibers 612. The forward end 606 of the ferrule 610 and the terminating ends of the optical fibers 612 are accessible via the forward end 606 of the connector inner housing 614. As will be understood by those skilled in the art, the connector inner housing 614 contains notches 620, which allow the connector plug 600 to be secured to a corresponding receptacle socket 700. The connector inner housing notches 620 are engaged during insertion of the connector plug 600 into the receptacle socket 700. The receptacle socket contains hooks 702 configured to interact with the notches 620 found on the connector inner housing 614. The connector outer housing 616 includes a shoulder 622 on the forward end of the housing that is configured to prevent disengagement of the receptacle socket hooks 702, from the inner housing notches 620 by sliding between the hooks 702 and the inner surface 704 of the outer wall 706 of the receptacle socket 700 during insertion.

When the user desires to disconnect the connector plug 600 from the receptacle socket 700, the user must grasp the connector plug outer housing 616 and exert a force directed away from the receptacle socket 700. When a force opposite the receptacle socket 700 is exerted on the connector plug outer housing 616, the outer housing 616 slides away from the receptacle socket 700 while the inner housing 614 remains connected by way of the receptacle hooks 702 and inner housing notches 620. As the outer housing 616 slides away from the receptacle socket 700, the outer housing shoulder 622 is removed from the space between the receptacle socket outer wall 706 and the receptacle hooks 702. When the connector outer housing 616 reaches the rearward limit of its ability to slide with respect to the inner housing 614, the outer housing 616 abuts the rear shoulder of the inner housing 614, thus the force applied by the user onto the connector outer housing 616 is transferred to the connector inner housing 614. Because the connector outer housing shoulder 622 has been removed, nothing prevents the receptacle hooks 702 from disengaging from the connector inner housing notches 620 when the removing force is transferred to the connector inner housing 614.

A connector outer enclosure 624, having a generally rectangular cross section, is adjacent to the rearward end 608 of the connector inner housing 614. The connector outer enclosure 624 surrounds and protects the fiber optic line 604. The connector outer enclosure 624 also provides a secure surface that may be grasped by a user when the connector plug 600 is inserted into a receptacle socket 700. A user may grasp the connector outer enclosure 624 in order to insert the connector plug 600 into a receptacle socket 700 without damaging the fiber optic line 604. A strain relieving boot 626 is adjacent to the rearward end 608 of the connector outer enclosure 624. The strain relieving boot 626 protects the fiber optic line 604 from forces applied to the line 604 that may otherwise cause damage or disruption to the optical fibers 612 were the line 604 to be disconnected from the connector plug 616.

The receptacle socket 700 includes an inner housing 708 and an outer housing 710. The receptacle outer housing 710 encloses the receptacle inner housing 708 and contains flanges 712 that are configured to mount on a variety of surfaces.

Referring now to FIG. 7 and FIG. 8, the illustrated embodiment shows an MTP type connector 800 including an inner housing 802 and the outer housing 804, that may be connected to a receptacle socket 900. The connector ferrule (with optical fibers) has been omitted from the illustrated embodiment so that the features of the present invention may be more clearly seen. The connector plug 800 includes keying features comprised of connector protrusions 806 and connector channels 808 which may be molded or machined onto the outer surface of the connector inner housing 802, or onto the inner or outer surface of the connector outer housing 804. A pair of inner housing notches 810 engages the latching features found on a corresponding receptacle socket in the same manner as described above with respect to the MTP connector plug and receptacle socket shown in FIG. 5 and FIG. 6.

The receptacle inner housing 902 contains various keying features which are configured to mate with the keying features found on the outer surface of the connector inner housing 802. The receptacle inner housing 902 contains protrusions 904 and channels 906 that may be molded or machined onto the inner surface of the receptacle socket 900. Thus, the connection system of the present invention is configured to provide for the mating of a connector protrusion 806 with a receptacle channel 906, in order that a properly keyed connector plug 800 may interconnect with a properly keyed receptacle socket 900. Likewise, a receptacle protrusion 904 mates with a connector channel 808 when a properly keyed receptacle socket 900 receives a properly keyed connector plug 800. The keying features physically restrict the interconnection between a connector plug 800 and a receptacle socket 900 when one or both of the devices are not keyed or are improperly keyed. It should be noted that the number and position of the keying features shown in the illustrative embodiments are by way of example, not limitation. The keying features found in the present invention may include one or more protrusions and/or channels as desired in order to increase or decrease the complexity of the overall connection system. Similarly, the keying features may be positioned in any manner which does not interfere with the operation of the latching features found on the connector plug 800, nor the receptacle socket 900. A raised tab 812 located on the connector inner housing 802 may be configured to mate with a recessed channel 908 located on the inner surface of the receptacle socket 900, thus serving to properly align the connector plug 800 with the receptacle socket 900 during insertion. It should be noted that keying features of present invention may serve to align the connector plug 800 with the receptacle socket 900, thus removing the need for dedicated alignment features.

Referring now to FIG. 9, an illustrative embodiment of an MTP type connector plug's 800 (not shown) outer housing 804. The inner surface of the connector outer housing 804 contains keying features such as channels 1000, which may be configured to mate with the various keying features found on both the connector inner housing 802 as well as those found on the receptacle socket 900.

Referring now to FIG. 10, an illustrative embodiment of an MTP connector plug 800 mated with an MTP receptacle socket 900. A receptacle socket outer housing 1100 surrounds the receptacle socket inner housing 902. The receptacle socket 900 shown in the illustrative embodiment shows only that portion of the socket which interconnects with the connector plug 616 and omits the second fiber optic line (not shown) and portion of the receptacle socket that houses the second line (not shown). The receptacle socket outer housing allows 1100 mounting of the receptacle socket 900 onto a plurality of outer surfaces. The receptacle socket outer housing 1100 may include flanges (not shown) capable of mounting the device to a variety of surfaces.

Referring now to FIG. 11, an illustrative embodiment of an MTP type connector plug's inner housing 802. The inner housing 802 contains keying features comprising protrusions 806 and channels 810, which are configured to mate with the keying features of both the connector outer housing 804 and the receptacle socket 900. As previously mentioned, the keying features may be located in any position which will not interfere with the latching features on the connector plug 800, nor the receptacle socket 900. The length, width, and depth of any protrusion or channel may vary in dimension as desired to provide for additional complexity of the connection system.

Referring now to FIG. 12, an illustrative embodiment of the inner housing 902 of an MTP style receptacle socket 900. The receptacle inner housing 902 contains keying features including receptacle protrusions 904 and receptacle channels 906 that are configured to mate with the corresponding keying features of a connector plug 800. The latching features found on the inner housing 902 are comprised of hooks 1300 which engage with the notches 810 found on the connector plug 800, functioning in the same manner as was described above with reference to the connector plug 600 and receptacle socket 700 of FIG. 5 and FIG. 6 respectively.

It should be noted that the descriptions and embodiments disclosed herein are not exhaustive and are illustrative only. Many modifications and variations will be apparent to those of ordinary skill in the art. Accordingly, the protection sought herein is as set forth in the claims below.

1. A connection system for providing selective interconnection between a connector plug and a socket, the connection system comprising:
a connector plug having an inner housing mounted within an outer housing, said inner housing including one or more predefined first keying geometries formed thereon, said outer housing including one or more second keying geometries formed thereon, wherein at least one of the one or more first and second keying geometries comprise first and second aligned slots respectively formed in said inner and outer housings; and
a socket adapted to receive said connector plug, said socket having an inner surface including one or more third keying geometries formed thereon;
wherein said third keying geometries are adapted to mate with said first keying geometries and said second keying geometries, wherein one of the one or more third keying geometries engages said aligned slots so as to pass through the outer housing to the inner housing.

2. The connection system of claim 1 wherein said first keying geometries are formed on an outer surface of said inner housing.

3. The connection system of claim 1 wherein said second keying geometries are formed on an inner surface of said outer housing.

4. The connection system of claim 1 wherein said second keying geometries are formed on an outer surface of said outer housing.

5. The connection system of claim 1 wherein said inner housing and said outer housing are generally rectangular in the cross section and each have a first pair of opposing sides and a second pair of opposing sides, each of said first pair of opposing sides having first latching means formed thereon, said second pair of opposing sides of the inner housing having said first keying geometries formed thereon, said second pair of opposing sides of the outer housing having said second keying geometries formed thereon, said first latching means being adapted to engage second latching means formed on said socket.

6. The connection system of claim 1 wherein the connector plug is a push-pull type connector.

7. The connection system of claim 1 wherein the connector plug is one of an MTP, MPO, MU or SC type connector.

8. The connection system of claim 1 wherein said outer housing and said inner housing are adapted to move relative to one another.

9. A connection system for providing selective interconnection between a connector plug and a socket, the connection system comprising:
connector plug having an inner housing mounted within an outer housing, each of said inner housing and outer housing including an outer surface having one or more connector protrusions formed thereon, the outer surface of said inner housing also having at least one connector channel formed therein; the outer surface of said outer housing having one or more slots formed therein; and
a socket adapted to receive said connector plug, said socket having an inner surface including at least one socket protrusion formed thereon and at least one socket channel formed therein;
wherein each of said connector protrusions formed on the outer surface of said inner housing extends through one of said slots, and each of said inner-housing connector channels is adjacent to a similarly dimensioned outer-housing slot to form a channel-socket pair;
wherein each of said connector protrusions is adapted to mate with one correspondingly dimensioned socket channel and each socket protrusion is adapted to mate with one channel-socket pair.

10. The connection system of claim 9 wherein said inner housing and said outer housing are generally rectangular in the cross section and each have a first pair of opposing sides and a second pair of opposing sides, said first pair of opposing sides having first latching means formed thereon, said second pair of opposing sides having connector protrusions, connector channels, or slots formed thereon, said first latching means being adapted to engage second latching means formed on said socket.

11. The connection system of claim 9 wherein each connector channel has a length and width that is substantially similar to a length and width of said adjacently formed slot.

12. The connection system of claim 9 wherein the connector plug is a push-pull type connector.

13. The connection system of claim 9 wherein the connector plug is one of an MTP, MPO, MU or SC type connector.

14. The connection system of claim 9 wherein said outer housing and said inner housing are adapted to move relative to one another.

15. (canceled)

16. A connection system for providing selective interconnection between a connector plug and a socket, the connection system comprising:
a connector plug having an inner housing mounted within an outer housing, said inner housing including one or more predefined first keying geometries formed thereon, said outer housing including one or more second keying geometries formed thereon, wherein the first keying geometry is offset radially from the second keying geometry; and
a socket adapted to receive said connector plug, said socket having an inner surface including one or more third keying geometries formed thereon;
wherein said third keying geometries are adapted to mate with said first keying geometries and said second keying geometries in one orientation to prevent improper insertion.

17. The connection system of claim 16, wherein the third keying geometry is configured to interfere with a portion of the inner housing if the connector plug is improperly keyed.

18. The connection system of claim 16, wherein the third keying geometry is configured to interfere with a portion of a non-keyed connector plug.
